(19) United States
(12) Patent Application Publication
(10) Pub. No.: US 2011/0147555 A1
(43) Pub. Date: Jun. 23, 2011

(54) VARIABLE LENGTH STANDOFF ASSEMBLY

(75) Inventors: Bryan K. Harris, Sandy, UT (US); Jeremy Porter, Salt Lake City, UT (US)

(73) Assignee: 3FORM, INC., Salt Lake City, UT (US)

(21) Appl. No.: 12/673,461

(22) PCT Filed: Aug. 30, 2008
(86) PCT No.: PCT/US08/74948

§ 371 Date: Feb. 12, 2010

Related U.S. Application Data
(60) Provisional application No. 60/969,448, filed on Aug. 31, 2007.

(51) Int. Cl. F16M 13/00; B23P 11/00; B23P 17/00

(52) U.S. Cl. 248/286.1; 248/298.1; 29/525.02; 29/464

(57) ABSTRACT

A variable length standoff assembly is configured to mount one or more portions of one or more panels to a frame or support structure, regardless of curvature or angling in the given panel or frame. The variable length standoff assembly includes a connector bar to which one or more variable length standoffs can be attached. Each variable length standoff includes a standoff barrel and adjustable extender to which a manufacturer can attach a portion of a given panel via a mounting cap. Each variable length standoff can be rotated about the connector bar, and can be extended or shortened to a wide range of lengths. In one implementation, a variable length standoff can also be configured to rotate with respect to the connector bar in at least two planes, thereby providing additional degrees of freedom for attaching variously curved and/or differentially orientated panels to a support structure.

### CROSS-REFERENCE TO RELATED APPLICATIONS

The present invention is a 371 U.S. National Stage of PCT Application No. PCT/US08/74948, filed Aug. 30, 2008 entitled “Variable Length Standoff Assembly,” which claims the benefit of priority to U.S. Provisional Application No. 60/969,448, filed Aug. 31, 2007, entitled “Variable Length Standoff Assembly.” The entire content of the above-mentioned applications are incorporated by reference herein.

### BACKGROUND OF THE INVENTION

1. The Field of the Invention

The present invention relates generally to systems, methods, and apparatus for mounting and/or displaying panels as partitions, displays, barriers, treatments, or other structures.

2. Discussion of the Relevant Art

Recent trends in building design involve adding to the functional and/or aesthetic characteristics of a given structure or design space by mounting one or more decorative architectural panels thereto. This is at least partly since there is sometimes more flexibility with how the given panel (or set of panels) is designed, compared with the original structure. For example, decorative architectural panels are often mounted as partitions, walls, decor, barriers, treatments, and other structures in homes, offices, and other buildings.

In general, decorative architectural panels can be composed of a wide range of different materials. For example, decorative architectural panels can be made of any number of naturally or synthetically occurring metallic, glass, or resin-based materials, such as polyvinyl chloride or “PVC”; polyacrylate materials such as poly(methyl methacrylate) or “PMMA”; polyester materials such as poly(ethylene-co-cyclohexane 1,4-dimethanol terephthalate), or “PET”; poly(ethylene-co-cyclohexane 1,4-dimethanol terephthalate glycol), or “PETG”; glycol modified polycyclohexylenedimethlene terephthalate, or “PCTG”; as well as polycarbonate, or “PC”, materials, and combinations thereof. More recently, resin-based panels have become more popular due to their relative flexibility, relative light weight, and relative ease by which resins can be modified or formed into various decorative shapes at comparatively low cost. Resin-based panels can also provide more flexibility compared with glass or other conventional panels at least in terms of color, degree of texture, gauge, and impact resistance. Decorative resin-based materials have a fairly wide utility since they may be formed to include a large variety of artistic colors, images, and shapes. Additionally, resins may provide certain advantages in terms of recycling and reuse.

These and other types of similar materials allow a manufacturer to assemble or otherwise create virtually any size, shape, gauge, color, or the like of a given panel (or sets of panels). In particular, resin-based materials can be formed for flat or three-dimensional (i.e., curved) formations, such as with compound curvatures. As a result, these and other similar types of panel materials have a fairly wide functional and aesthetic utility, and can be used to readily update and change the design and function of an existing structure.

Unfortunately, conventional panel mounting systems generally do not provide much flexibility in terms of mounting style or arrangement without relatively complicated hardware and installation processes. For example, conventional mounting hardware is often only configured for use with flat panels, and typically does not account for the variable, curved surfaces of more complex-shaped panels. Thus, conventional mounting hardware, which tends to be rigid and inflexible, is often ill-equipped to mount curved panels, or to mount panels in varied angles and orientations relative to an underlying structure. When such conventional hardware is used, the hardware often contacts the panel at undesired orientations that cause stresses to concentrate in areas or points of the resin panel, which can cause a panel to crack.

In addition, the few conventional mounting hardware options that can be used to secure panels in angled positions typically require complicated installation processes and do not allow ready assembly, disassembly, or reconfiguration. For example, one conventional panel mounting system includes constructing a frame into which each panel is inserted. Mounting a curved panel in a frame, however, often is difficult, time consuming, and expensive. For example, the curved panel could be inserted into a frame, such as a wood or steel frame that is configured with curving that corresponds to the curved panel. Constructing such a frame, however, can be difficult, if not prohibitively expensive for relatively complex curvatures. In particular, even slight mismatches in frame design can result in stress and/or cracking of a resin-based panel. One will appreciate that similar issues such as these can occur even with panels that may not be curved, but have differential shaping or sizing due to manufacturing inconsistencies. These manufacturing inconsistencies can create problems when attempting to mount several different panels together in a seamless fashion, even where framing is appropriately accommodating on some panel edges.

Other conventional solutions for mounting panels to a structure (e.g., wall, ceiling, or corresponding frame) include using one or more standoffs. In general, a standoff positions a panel at a “standoff” (or extended) position with respect to a support structure, where the standoff position is a distance defined generally by a length of a portion of the standoff (i.e., the standoff barrel). To this end, a conventional standoff typically includes a standoff barrel that attaches to the given support structure on one end, and a cap that has a threaded stem configured to twist inside an opposing end of the barrel. The standoff cap and barrel are generally configured to screw together with substantially flat, opposing surfaces. For example, the standoff cap and stem might be threaded through one side of a given perforation in a panel. The cap and stem of the standoff might then be screwed into the standoff barrel on an opposing side of the panel perforation.

Unfortunately, like frames, conventional standoffs suffer from a number of drawbacks, and are typically not suitable for mounting panels with complex curvatures. In particular, the flat surfaces of the conventional standoff cap and barrel limit the degree to which the cap and barrel can be secured against certain types of panel curvatures. Furthermore, since conventional standoffs used with a frame and support structure tend to all be the same length and approximately same orientation, this can further limit the type and shape of panels to be mounted.

In some cases, a manufacturer may attempt to accommodate the curvature of a given panel by attaching the conventional standoff too loosely or too tightly against the panel and frame. One can appreciate, however, that too loose of a bind can result in inappropriate shifting of the panel. By contrast, attaching the panel to the standoff too tightly can result in one or more components of the standoff digging into the panel curvature, which can result in cracks or fissures of the panel. Furthermore, creating a complex frame (or set of frame elements) that allows attachment of each standoff at various angles of panel curvature (e.g., curved framing) can be prohibitively expensive.

Additionally, conventional panel mounting hardware and systems, such as frames and conventional standoffs, tend to employ very little (or no) ability to adjust to non-standard mounting surfaces. Thus, the use of conventional panel mounting hardware and systems can be problematic when used on slanted, uneven, or misaligned floors, walls, and ceilings due to construction errors or the settling of a building or other structure. Indeed, attempting to align a plurality of panels using conventional panel mounting systems mounted to non-standard mounting surfaces can be impossible or at the very least require time consuming and expensive modifications and complicated installation procedures.

Accordingly, there are a number of disadvantages in conventional panel mounting hardware and systems that can be addressed.

### BRIEF SUMMARY OF THE INVENTION

Implementations of the present invention overcome one or more problems in the art with systems, methods, and apparatus for securely mounting decorative architectural panels with a great deal of versatility. In particular, implementations of the present invention include mounting systems and components configured to variably mount panels almost regardless of panel geometry and panel angle or orientation. For example, implementations of the present invention include variable length standoff assemblies which can be elongated or shortened, and can even be rotated relative to a support structure in one or more planes, as may be necessary to accommodate various panel curvatures and alignments/orientations.

For example, a variable length standoff assembly for mounting one or more panels to a support structure with variable distance or angling therebetween can include a standoff barrel configured to be secured to a support structure on one end. The variable length standoff assembly can further include a standoff extender configured to secure at least a portion of a panel to the standoff barrel with variable distance. Additionally, the standoff extender can be coupled to the standoff barrel in a telescoping manner such that the standoff extender can secure a panel to the support structure in a plurality of different contracted or extended positions relative to the standoff barrel.

In addition, a standoff assembly according to another implementation of the present invention includes at least one connector bar secured to a support surface. The standoff assembly can further include a plurality of variable length standoffs secured to the at least one connector bar, including at least one standoff adjusted to secure a panel portion to the support surface at one angle, and at least another standoff adjusted to secure another panel portion to the support surface at another angle. Additionally, the orientation of each variable length standoff of the plurality of variable length standoffs can be configured to be individually adjusted in distance or angle relative to the at least one connector bar in at least one plane.

Furthermore, a method of securely assembling a panel to a support structure in accordance with an implementation of the present invention can include securing at least one connector bar of a variable length standoff assembly to a support structure, wherein the variable length standoff assembly comprises at least one adjustable, variable length standoff. The method can also include rotating at least one variable length standoff of the standoff assembly about the at least one connector bar in one or both of a first and a second plane. In addition, the method can include adjusting a length of the at least one variable length standoff assembly relative to the connector bar. Furthermore, the method can include mounting at least one panel to the at least one variable length standoff.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic diagram of a side view of panel system including a plurality of curved panels mounted to a support structure to a wall and a ceiling using a plurality of variable length standoff assemblies individually adjusted to accommodate for the curvature and orientation of each panel in accordance with one or more implementations of the present invention;

FIG. 2 illustrates a side-view schematic diagram of a variable length standoff assembly rotatable in one plane about a connector bar in accordance with an implementation of the present invention;

FIG. 3 illustrates an exploded, perspective-view schematic diagram of the variable length standoff assembly shown in FIG. 2;

FIG. 4 illustrates a side-view schematic diagram of a variable length standoff assembly rotatable in two planes about a connector bar in accordance with an implementation of the present invention;

FIG. 5 illustrates an exploded, perspective-view of the variable length standoff assembly shown in FIG. 4; and

FIG. 6 illustrates an end-view schematic diagram of the variable length standoff assembly shown in FIG. 4, further showing an angle tool which can be used to align the variable length standoff assembly in a particular orientation in accordance with an implementation of the present invention.

### DETAILED DESCRIPTION OF THE PREFERRED EMBODIMENTS

The present invention is directed toward systems, methods, and apparatus for securely mounting decorative architectural panels with a great deal of versatility. In particular, implementations of the present invention include mounting systems and components configured to variably mount panels almost regardless of panel geometry and panel angle or orientation. For example, implementations of the present invention include variable length standoff assemblies which can be elongated or shortened, and can even be rotated relative to a support structure in one or more planes, as may be necessary to accommodate various panel curvatures and alignments/orientations.

As will be appreciated more fully herein, implementations of the present invention provide the ability to securely mount curved and/or variously oriented panels without damaging the panels. In particular, implementations of the present invention provide variable length standoff assemblies that can be adjusted in both length and orientation in one or more planes to ensure mounting components engage panels along desired interfaces, and do not dig into or otherwise stress/damage the panels. Furthermore, the length and angle/orientation adjustable mounting systems and components of the present invention can be used to mount panels in a wide range of design spaces, almost regardless of dimensional variations and surface mounting features, such as slanted, misaligned, and varied surfaces.

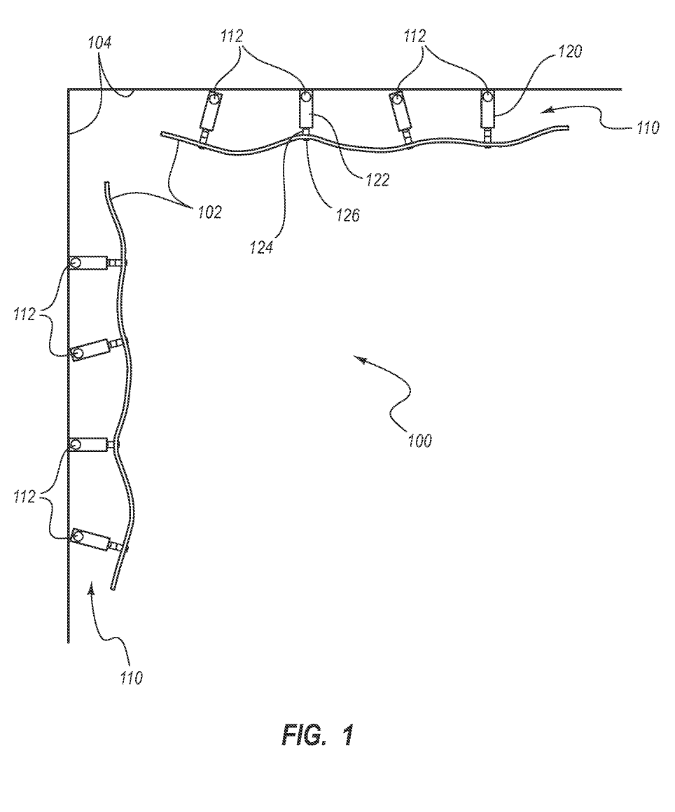

For example, FIG. 1 illustrates a schematic diagram of a panel system 100 in accordance with an implementation of the present invention comprising a plurality of panels 102 mounted to one or more underlying support structures 104 (e.g., a wall and a ceiling). As shown, one or more variable length standoff assemblies 110 secure each panel 102 of the plurality of panels to the support structure 104. As explained in further detail below, the variable length standoff assemblies 110 securely mount, without damaging, the panels 102, while also accommodating for any panel curvature, panel angle/orientation, and/or support structure variances.

As used herein, the term “panel” refers primarily to resin-based panels, such as panels comprising materials of one or more layers or sheets formed from any one of the following thermoplastic polymers (or alloys thereof). Specifically, such materials include but are not limited to, polyethylene terephthalate (PET), polyethylene terephthalate with glycol-modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high density polyethylene, polypropylene), thermoplastic polyurethane (TPU), cellulose-based polymers (cellulose acetate, cellulose butyrate, or cellulose propionate), or the like. In addition to resin-based panels, the term “panel,” as used herein, also comprises panels formed partly or entirely from other materials including metal, wood, glass, or glass composites.

Furthermore, the panels 102 disclosed herein can generally comprise panels of at least about six inches by about six inches (6″×6″) in width/height dimension in at least one implementation. One will appreciate, however, that the size (i.e., surface area) of the panels 102 can also be any appropriate size for the resulting size of the panel system 100. In at least one implementation, for example, the panels 102 can be about can be about twelve inches by about twelve inches (12″×12″), four feet by about eight feet (4′×8′), about four feet by about ten feet (4′×10′), about six feet by about fifteen feet (6′×15′), or taller/wider. Furthermore, the panels 102 can be any appropriate thickness for the resulting thickness of a panel system 100, such as about two inches (2″), about one inch (1″), about one-half inch (½″), about one-fourth inch (¼″), about one-eighth inch (⅛″), about one-sixteenth inch ( 1/16″), or about one-thirty-second inch ( 1/32″) in thickness or gauge as desired. Thus, both the gauge and size of the panels 102 can be tailored depending upon the desired dimensions of a panel system 100.

In addition to varying the geometry/size of the panels 102, a manufacturer/assembler can vary the transparency and/or color of the panels to provide a desired aesthetic. For example, if the panels 102 forming the panel system 100 illustrated in FIG. 1 are opaque, the panels 102 will tend to hide or conceal the variable length standoff assemblies 110 since each variable length standoff assembly 110 is positioned behind a given panel 102. In such an implementation, the panels 102 may reduce the visibility of hardware (e.g., 112, 120) used to mount the panels 102 to the pre-existing support structure 104.

In additional embodiments, however, the panels 102 can be transparent, translucent, and/or colored, as desired. When transparent or translucent panels 102 are used, the variable length standoff assemblies 110 can be at least partially visible through the panels 102. Furthermore, a manufacturer/assembler can form the panels 102 to include embedded two or three-dimensional objects such as thatch, willow reed, coffee beans, bamboo, and similar objects in order to provide a desired aesthetic. Thus, one will appreciate that a manufacturer/assembler can create panel systems using panels 102 including any number or combinations of different aesthetic features (e.g., color, transparency, surface texture, embedded objects, or printed images). Furthermore, a manufacturer/assembler can use a variety of panels each with similar or different aesthetic features to provide a desired overall aesthetic.

Referring again to the Figures, FIG. 1 illustrates a panel system 100 mounted using at least one variable length standoff assembly 110 according to an implementation of the present invention. As shown in FIG. 1, the variable length standoff assembly 110 can include one or more connector bars 112 secured to a support structure 104. Additionally, the variable length standoff assembly 110 can further include one or more variable length standoffs 120 secured to the one or more connector bars 112. Each variable length standoff 120 can include a standoff barrel 122, a standoff extender 124, and a mounting cap 126. Each panel 102 can, in turn, be secured between each standoff extender 124 and mounting cap 126.

As mentioned previously, according to one implementation of the present invention, each variable length standoff assembly 110 can securely mount, without damaging, the panels 102, while also accommodating for any panel curvature, panel angle/orientation, and/or support structure variances. For example, FIG. 1 illustrates a variable length standoff assembly 110 that includes a plurality of variable length standoffs 120, each of which a manufacturer/assembler can individually adjust in length (i.e., lengthen or shorten). The manufacturer/assembler can adjust each variable length standoff 120 to accommodate for the increased or decreased distance between each panel 102 and the support structure 104 due to the curvature of each panel 102. In particular, the manufacturer/assembler can slide each standoff extender 124 of each variable length standoff assembly 110 relative to its corresponding standoff barrel 122 to adjust the length of each variable length standoff 120 as needed.

One will appreciate that in addition to being adjusted to accommodate for panel curvature, a manufacturer/assembler can adjust the length of each variable length standoff 120 to accommodate for any increased/decreased distance between the support structure 104 and the panels 102 due to panel orientation. For instance, a manufacturer/assembler may desire to angle a panel 102 away from a support structure 104 to provide a desired aesthetic. In such a case, the manufacturer/assembler can adjust the length of each variable length standoff 120 to accommodate for the angling of each panel 102. Similarly, a manufacturer/assembler may desire to mount a panel system 100 to a support structure 104 with non-standard support surfaces (i.e., uneven surfaces, angled surfaces, or misaligned surfaces etc.). In such cases, the manufacturer/assembler can adjust the length to of each variable length standoff 120 of each variable length standoff assembly 110 to accommodate for any such surfaces variances. Thus, one will appreciate that the individual length adjustability of each variable length standoff 120 can provide a manufacturer/assembler with a great deal of functional versatility.

In addition to adjusting each variable length standoff 120 in length, a manufacturer/assembler can also individual adjust the orientation of each variable length standoff assembly 110 relative to a corresponding connector bar 112 or support surface 104 in at least one plane. For example, FIG. 1 illustrates that the manufacturer/assembler has assembled each standoff 120 so that many of the standoffs 120 are titled relative to the next adjacent standoff. Specifically in at least one implementation, the manufacturer can rotate each variable length standoff 120 of each variable length standoff assembly 110 relative to its respective connector bar 112 to accommodate for the curvature of each panel 102.

In addition to adjusting the orientation of each variable length standoff assembly to accommodate for panel curvature, a manufacturer/assembler can similarly adjust the orientation of each variable length standoff 120 to accommodate for panel orientation and/or any surface variances of any non-standard mounting surfaces 104. As shown in FIG. 1, a manufacturer/assembler can rotate each variable length standoff 120 relative to its corresponding connector bar 112 in a single plane. In additional implementations, however, as explained in greater detail below, a manufacturer/assembler can rotate each variable length standoff 120 about its respective connector bar 112 in two planes to allow for even greater mounting versatility.

Thus, as shown in FIG. 1, a manufacturer/assembler can adjust a first variable standoff 120 to secure a panel 102 or portion thereof to the support surface 104 at a first angle. Also, the manufacturer/assembler can adjust at least a second variable length standoff to secure another portion of panel 102 to the support surface at another or different angle. Furthermore, as explained in greater detail below, a manufacturer/assembler can adjust a first standoff to a secure a panel 102 or a portion thereof to a support surface at a first angle in a first plane and a second angle in a second plane. Additionally, the manufacturer/assembler can secure at least a second variable length standoff 120 at a third angle in the first plane and a fourth angle in the second plane. Thus, one will appreciate that a variable length standoff assembly 110 can include a plurality of variable length standoffs each adjusted to one or more angles in one or more planes.

By individually adjusting the angle of each variable length standoff 120 in one or more planes relative to its corresponding connector bar 112 or support surface and adjusting each variable length standoff 120 in length, a manufacturer/assembler can ensure that the mounting interfaces created between each panel 102, extender 124, and cap 126 do not create undesired concentrated or point stresses in the panels 102. For example, a manufacturer/assembler can adjust each variable length standoff 120 in angle/orientation and/or length to enable the mounting cap 126 to be properly tightened over the panel 102. Thus, a manufacturer/assembler can avoid the need to over-tighten a mounting cap 126 which can cause the extender 124 or mounting cap 126 to dig into and create point stresses in a panel 102, and eventually lead to panel damage. Similarly, a manufacturer/assembler can avoid the need to leave a mounting cap 126 loosened to accommodate for panel curvature, and thus, avoid any panel slippage caused thereby.

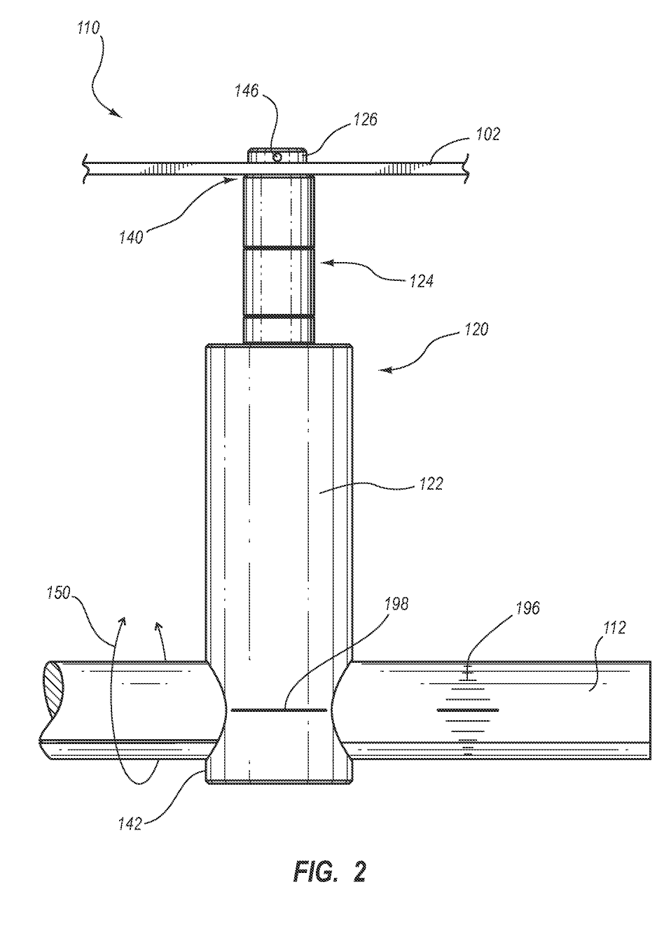

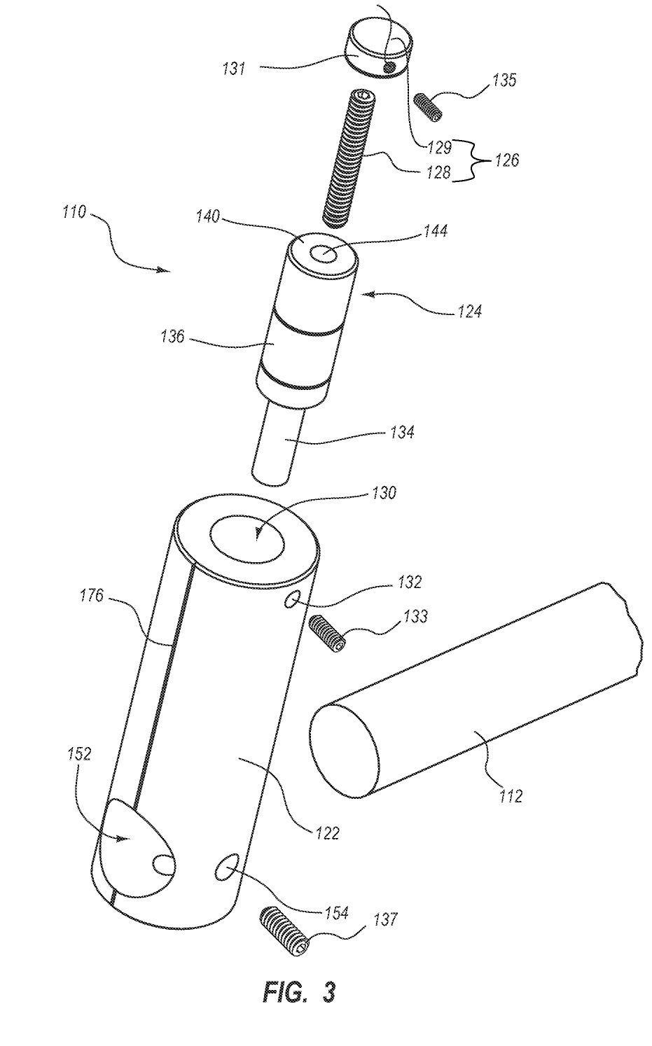

FIGS. 2 and 3, and the corresponding text, illustrate or describe a number of different, additional details and features/uses of the variable length standoff assembly 110 shown in FIG. 1. For example, FIG. 2 illustrates a side view of a variable length standoff assembly 110 shown in FIG. 1. FIG. 3, on the other hand, illustrates an exploded, side-perspective view of components of the variable length standoff assembly 110 of FIG. 2.

As shown in FIGS. 2 and 3, each variable length standoff assembly 110 can include one or more variable length standoffs 120 secured to one or more connector bars 112. As mentioned previously, each variable length standoff 120 can include a standoff barrel 122, a standoff extender 124, and a mounting cap 126. According to an implementation of the present invention, a manufacturer/assembler can adjust the length of each variable length standoff 120. For example, FIGS. 2 and 3 illustrate that a manufacturer/assembler can adjust the length of a variable length standoff 120 of a variable length standoff assembly 110 by sliding the standoff extender 124 relative to the standoff barrel 122. Thus, according to one or more implementations, the standoff extender 124 can secure a panel to a support structure in a plurality of different contracted or extended positions relative to its corresponding standoff barrel 122.

Furthermore, the standoff extender 124 and standoff barrel 122 can be particularly configured so that the standoff extender 124 is coupled to the standoff barrel 122 in a telescoping manner. For example, FIG. 3 illustrates that the standoff extender 124 can be slidably received within the one or more cavities 130 of the standoff barrel 122, and can also be moved along a central axis of the standoff barrel 122. According to other implementations of the present invention, however, the standoff barrel 122 can be configured to slide within one or more cavities formed within the standoff extender 124. In yet further implementations, the standoff extender 124 and standoff barrel 122 can each include corresponding channels or grooves formed in an outer surface. The corresponding channels or grooves can couple the standoff extender 124 to the standoff barrel 122 and enable the standoff extender 124 to move or otherwise be adjusted relative to the standoff barrel 122.

In any case, a manufacturer/assembler can slide, move, or adjust the standoff extender 124 along the standoff barrel 122 between a fully contracted position and a fully extended position. In the implementation shown in FIGS. 2 and 3, when in the fully extended position, the standoff extender 124 is at least partially—if not fully—pulled outside of the one or more cavities 130 of the standoff barrel 122. In contrast, when in the fully contracted position, the standoff extender 124 is partially—if not completely—slid within the one or more cavities 130 of the standoff barrel 122. One will appreciate that the variable length standoff 120 will have its greatest length when the standoff extender 124 is in the fully extended position. On the other hand, the variable standoff 120 will have its shortest length in the illustrated implementation when the standoff extender 124 is in the fully contracted position.

A manufacturer/assembler can thus vary the length of the variable length standoff 120 by positioning the standoff extender 124 in one of a plurality of positions between the fully extended position and the fully contracted position. Additionally, the variable length standoff 120 can further comprise an extender locking mechanism (e.g., for use with receptacle 132) for holding and adjusting the standoff extender 124 at various positions relative to the standoff barrel 122. Thus, a manufacturer/assembler can use the extender locking mechanism to lock the standoff extender 124 in a fixed position relative to the standoff barrel 122.

According to one implementation of the present invention, the extender locking mechanism can comprise a fastener, such as a set screw. For example, FIG. 3 illustrates that the standoff barrel 122 can comprise a transverse extender receptacle 132. The transverse extender receptacle 132 can be configured to receive a fastener 133, which a manufacturer/assembler can tighten within the transverse extender receptacle 132 until it engages and secures the standoff extender 124 in a fixed position. According to additional implementations of the present invention, the extender locking mechanism can comprise a clamp or a spring loaded button secured to the outer wall of the standoff extender 124, and configured to engage various surface features on the inner wall of the standoff barrel 122.

As mentioned previously, a manufacturer/assembler can adjust the length of the variable length standoff 120 by moving the standoff extender 124 relative to the standoff barrel 122. Accordingly, both the standoff extender 124 and the standoff barrel 122 can include corresponding geometry or features. For example, FIGS. 2 and 3 show that the standoff extender 124 can comprise an upper barrel 136 that is larger in diameter than a lower connector portion 134. Similarly, the one or more cavities 130 of the standoff barrel 122 can comprise a first, larger-diameter upper cavity and a second, smaller-diameter lower cavity corresponding in size and shape the upper barrel 136 and lower connector portion 134 of the standoff extender 124.

Furthermore, the standoff barrel 122 can comprise a flange or shelf (not shown) where the one or more cavities 130 transition between the larger-diameter upper cavity and the smaller-diameter lower cavity. The flange or shelf of the standoff barrel 122 can act as a stop to ensure that the standoff extender 124 is not received within the standoff barrel 122 beyond a certain point. Thus, the flange or shelf of the standoff barrel 122 can ensure that at least a portion of the standoff extender 124 extends beyond the standoff barrel 122 when in the fully contracted position. The portion of the standoff extender 124, which is not received within the standoff barrel 122 when in the fully contracted position, can ensure that a manufacturer/assembler can easily secure a panel 102 to the standoff extender 124. Furthermore, one will appreciate that, by including a flange or shelf within the standoff barrel 122, the standoff extender 124 can be prevented from sliding too deeply within the standoff barrel 122 and becoming difficult to adjust.

While not shown in the Figures, in at least one implementation, the lower connector portion 134 of the standoff extender 124 can be threaded. Correspondingly, the smaller-diameter lower cavity of the one or more cavities 130 of the standoff barrel 122 can be reciprocally threaded. Thus, in at least one implementation, a manufacturer/assembler can secure or otherwise position the standoff extender 124 within the standoff barrel 122 by screwing the standoff extender 124 into the standoff barrel cavity 122. Similarly, the manufacturer/assembler can adjust the length of the variable length standoff 120 by threading the standoff extender 124 into and out of the standoff barrel 122.

In addition, FIGS. 2 and 3 show that the standoff extender 124 can comprise multiple different segments that can be assembled together. For example, FIGS. 2 and 3 illustrates in implementation in which the upper barrel 136 of the standoff extender 124 can comprise three sections or pieces. One will appreciate that each such segment can also be reciprocally threaded, so that each segment can be positioned or otherwise attached together by mating each segment, and screwing each segment together. In at least one implementation, a manufacturer/assembler can configure each segment so that the segments can be continually added to each other for additional length, or detached for reduced length, as needed. Thus, one will appreciate that a manufacturer/assembler can vary the length of each variable length standoff 120 by sliding its standoff extender 124 relative to its corresponding standoff barrel 122, or by adding or removing additional segments to the standoff extender 124.

As shown in FIGS. 2 and 3, the variable length standoff 120 can also include a stepback in standoff diameter near the panel 102 that is attached thereto. That is, the diameter of the standoff extender 124 can be smaller than the diameter of the standoff barrel 122. One will appreciate that at least one advantage of this stepback in standoff diameter between the standoff extender 124 and the standoff barrel 122, is that it can minimize shadowing immediately behind a given panel 102, and otherwise reduce the visibility of the variable mounting assembly 110.

As mentioned previously, a manufacturer/assembler can secure a panel 102 to the distal end 140 of the standoff extender 124. As used herein, the terms “proximal” or “proximate” and “distal” or “distant” are in reference to any connector bar 112 to which a variable length standoff 120 is mounted. Therefore, the distal end 140 of the standoff extender 124 shown in FIG. 2 is the end secured farthest from the connector bar 112, which in turn is configured to be secured to an underlying support structure. On the other hand, FIG. 2 shows that a proximate end 142 of the standoff barrel 122 is the end closet to, and in FIG. 2 secured to, the connector bar 112.

FIGS. 2 and 3 also illustrate that a manufacturer/assembler can secure a given panel 102 to the standoff extender 124 via one or more mounting caps 126. For example, FIG. 3 shows the variable length standoff 120 can comprise a mounting cap 126 that can be screwed into (or otherwise attached to) the distal end 140 of the standoff extender 124. In particular, a threaded stem 128 of the mounting cap 126 can be threaded within a threaded receptacle 144 formed within the distal end 140 of the standoff extender 124.

According to at least one implementation of the present invention, the mounting cap 126 can comprise a single unitary component including a cap and threaded stem. According to additional implementations, the mounting cap 126 can include one or more separate components. For example, FIG. 3 illustrates that the mounting cap 126 can include a cap 129 and a threaded stem 128. The cap 129 can include a center portion 131 for receiving an end of the threaded stem 128 extending from the standoff extender 124, or for holding a threaded end to be inserted into a standoff extender 124. FIG. 2 also shows that the mounting cap 126 can comprise one or more transverse securing receptacles 146 for receiving a fastener 135, such as a set or hex screw, in order to lock or fix the cap 129 onto the threaded stem 128.

In one mode of assembly, therefore, a manufacturer/assembler can remove, attach, or otherwise replace a given mounting cap 126 with respect to a variable length standoff 120 by loosening the transverse securing screw 135, removing the cap 129 from the threaded stem 128, and repositioning a new cap 129 over the threaded stem 128. The manufacturer/assembler can then secure the cap 129 (or new mounting cap) to the threaded stem 128 via the transverse securing screw 135. One will appreciate that this ability to secure, loosen, and interchange caps 129 provides a manufacturer/assembler with a number of different options for choose different mounting caps as appropriate for a different panel color, panel curvature (e.g., a variably adjustable angled mounting cap), panel finish, or the like.

Furthermore, because the cap 129 and the threaded stem 128 of the mounting cap 126 can be separated, the cap 129 can be used with various lengths of threaded stems 128. Thus, the mounting cap 126 and the variable length standoff assembly 110 can be used with any gauge (thickness) of panel 102. This provides a manufacturer/assembler with great a deal of mounting flexibility. Also, this reduces the number of different parts need to assemble a panel system 100 (FIG. 1). For example, the same cap 129 and standoff extender 124 can be used with panels 102 of various or varying gauges. Additionally, a mounting cap 126, including a separable cap 129 and threaded stem 128, can reduce manufacturing difficulty. Specifically, manufacturing capabilities make long, one-piece capped fasteners commercially difficult to make because the stem tends to break. With a two-piece mounting cap 126, however, the threaded stem 128 can be manufactured separately from the cap 129, and thus, can be easily manufactured to longer lengths.

As mentioned previously, according to one or more implementations of the present invention, a variable length standoff 120, in addition to securing a panel 102 and allowing it to be positioned at a plurality of distances from a support surface, can be rotated in one or more planes relative to a connector bar or support surface. For example, FIG. 2 illustrates that a manufacturer/assembler can rotate the variable length standoff 120 about the connector bar 112 in the direction 150. According to one implementation of the present invention, the variable length standoff 120 can be rotated through a range of up to 360° relative to the connector bar 112. Thus, the manufacturer/assembler can rotate each variable length standoff 120 completely around the connector bar 112.

According to an implementation of the present invention, the variable length standoff 120 can be rotatably secured to the connector bar 112 to enable the variable length standoff 120 to rotate about the connector bar 112. For example, FIGS. 2 and 3 illustrate that the standoff barrel 122 of the variable length standoff 120 can be rotatably secured to the connector bar 112. In particular, FIGS. 2 and 3 show that the connector bar 112 is secured within a lower hollow portion 152 extending through the standoff barrel 122. This lower hollow portion 152 can comprise a hole formed in the lower or proximate portion of the standoff barrel 122. The geometry of the lower hollow portion 152 can be configured in shape and size to correspond with the geometry of the connector bar 112.

Additionally, the standoff barrel 122 can further comprise a connector bar locking mechanism (e.g., via receptacle 154) for holding and adjusting the standoff barrel 122 at various positions or angles relative to the connector bar 112. As understood more fully below, a manufacturer/assembler can use the connector bar locking mechanism to lock the variable length standoff 120 in a fixed position relative to the connector bar 112. According to one implementation of the present invention, the connector bar locking mechanism can comprise a fastener 137.

For example, FIG. 3 illustrates that the standoff barrel 122 can comprise a lower, transverse receptacle 154. The lower, transverse receptacle 154 can be configured to receive a fastener 137, such as a set screw, which a manufacturer/assembler can tighten within the lower, transverse receptacle 154 until it engages and secures the variable length standoff 120 in place relative to the connector bar 112. According to additional implementations of the present invention, the connector bar locking mechanism can comprise a clamp or other fastener. Thus, FIG. 3 illustrates that, in order to remove the variable length standoff 120 from the connector bar 112, or otherwise adjust the variable length standoff 120 relative to the connector bar 112, the manufacturer/assembler can loosen and tighten the transverse securing fastener 137 about or from receptacle 154, as necessary.

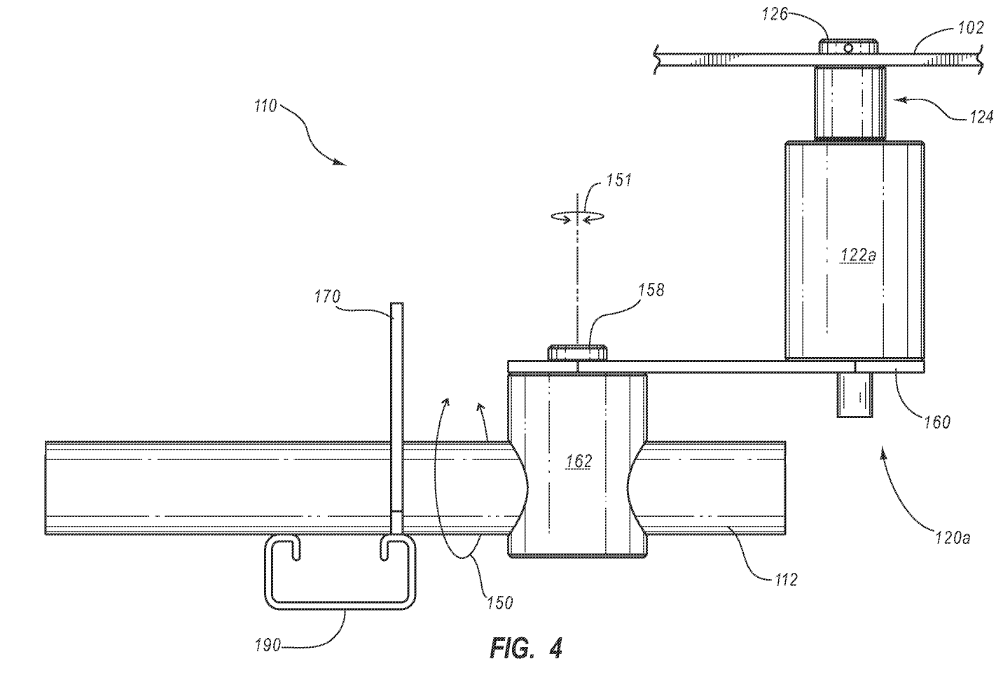

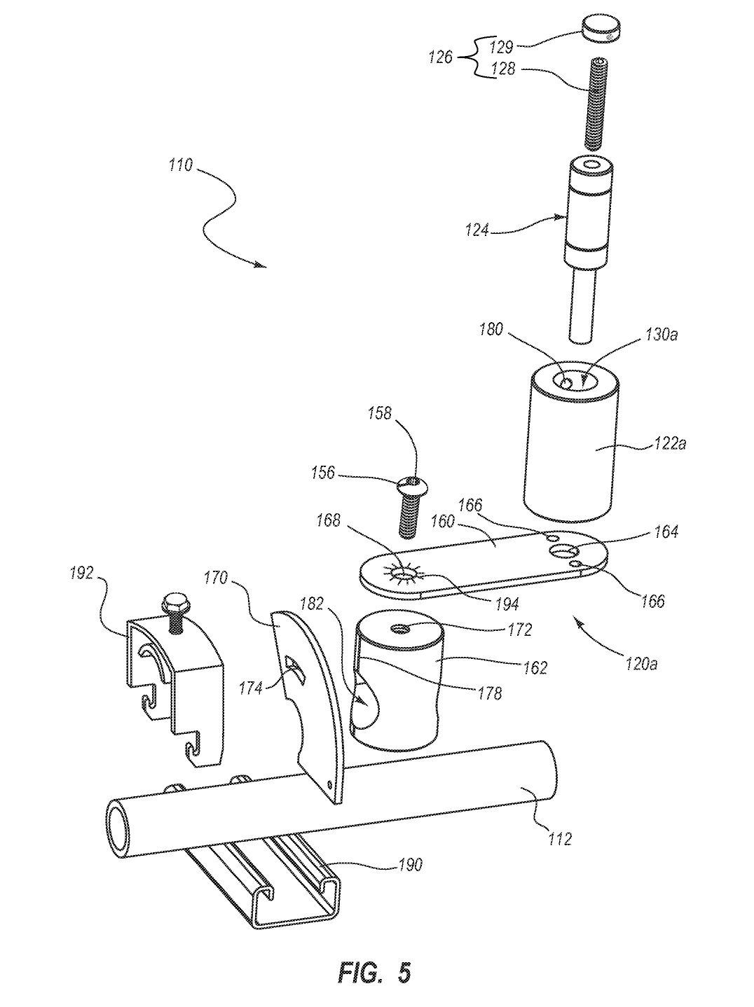

In addition to the foregoing, implementations of the present invention also include variable length standoffs that can be varied in angle in multiple planes. For example, FIGS. 4 and 5 illustrate a variable length standoff assembly 110 that includes a variable length standoff 120a adjustable in angle (i.e., rotatable) about a connector bar 112 in two different planes. In particular, as explained in greater detail below, a manufacturer/assembler can rotate the variable length standoff 120a through a range up to 360° relative to the connector bar 112 in the direction 150 in a first plane. Similarly, the manufacturer/assembler can independently rotate the variable length standoff 120a through a range up to 360° relative to the connector bar 112 in the direction 151 in a second plane.

As illustrated by FIGS. 4 and 5, the variable length standoff 120a comprises at least two base components, a lower, rotatable barrel component 162 and a standoff barrel 122a. Both the lower, rotatable barrel component 162 and the standoff barrel 122a can be attached to a swiveling or rotatable mounting plate 160. In general, the variable length standoff 120a comprises many of the same components as in the variable length standoff 120 previously described in relation to FIGS. 2 and 3; as such, similar references characters will be used for similar components to aid in description.

For example, FIGS. 4 and 5 show that a variable length standoff assembly 110 that is rotatable in multiple planes can comprise a variable length standoff 120a that includes a mounting cap 126, standoff extender 124, and standoff barrel 122a. The standoff extender 124 and standoff barrel 122a can be particularly configured so that the standoff extender 124 is coupled to the standoff barrel 122a in a telescoping manner, as described above in relation to standoff barrel 122 and standoff extender 124. Thus, a manufacturer/assembler can vary the length of the variable length standoff 120a by positioning the standoff extender 124 in one of a plurality of positions between a fully extended position and a fully contracted position relative to the standoff barrel 122a.

Also, similar to the previously described standoff barrel 122, the standoff barrel 122a can comprise one or more cavities 130a for receiving the standoff extender 124 therein. In at least one implementation, however, the one or more cavities 130a for receiving the standoff extender 124 can extend all the way through the standoff barrel 122a, and can register with an extender perforation 164 in the rotatable mounting plate 160. In one implementation, this allows the standoff extender 124 to attach (e.g., via threaded connection means) directly into the rotatable mounting plate 160.

Additionally, the variable length standoff 120 can further comprise an extender locking mechanism (e.g., via a receptacle 132, FIGS. 2-3) for holding and adjusting the standoff extender 124 at various positions relative to the standoff barrel 122a. (This is similar to the extender locking mechanism described above in relation to standoff barrel 122.) Thus, a manufacturer/assembler can use the extender locking mechanism to lock the standoff extender 124 in a fixed position relative to the standoff barrel 122a. According to one implementation of the present invention, the extender locking mechanism can comprise a fastener.

For example, FIG. 5 illustrates that the standoff barrel 122a can comprise a transverse extender receptacle 180. The transverse extender receptacle 180 can be configured to receive a set screw (not shown), which a manufacturer/assembler can tighten within the transverse extender receptacle until it engages and secures the standoff extender 124 in place. According to additional implementations of the present invention, the extender locking mechanism can comprise a clamp or a spring loaded button secured to the outer wall of the standoff extender 124, and configured to engage various surface features on the inner wall of the standoff barrel 122a.

One will note, however, that the standoff barrel 122a is generally configured to mount directly to the rotatable mounting plate 160, rather than directly to the connector bar 112 as in prior examples. For example, FIG. 5 shows that the rotatable mounting plate 160 can comprise one or more perforations 166 on a first end for receiving one or more fasteners (not shown), which a manufacturer/assembler can use to directly secure the standoff barrel 122a to the rotatable mounting plate 160. To this end, the standoff barrel 122a can comprise one or more corresponding securing receptacles that are essentially parallel to the one or more cavities 130a and extend from a proximate end of the standoff barrel 122a therein. Thus, a manufacturer/assembler can insert the one or more fasteners (not shown) through the one or more perforations 166 of the rotatable mounting plate 160 and into the corresponding parallel, securing receptacles of the standoff barrel 122a. The manufacturer/assembler can then secure the fasteners within the parallel, securing receptacles of the standoff barrel 122a to fix the standoff barrel 122a on to the rotatable mounting plate 160.

At an opposing or second end, the rotatable mounting plate 160 can attach to lower, rotatable barrel component 162. In particular, the rotatable mounting plate 160 can be secured to the lower, rotatable barrel component 162 in a rotatable (but securable) fashion. For example, FIG. 5 illustrates that rotatable mounting plate 160 can include another perforation 168; and the lower, rotatable barrel component 162 can include a corresponding perforation 172. Each of the perforations 168, 172 can be configured to receive a pivot rod 158. For example, a manufacturer/assembler can insert the pivot rod 158 through the perforation 168 and into the perforation 172 to rotatably secure the lower, rotatable barrel component 162 to the rotatable mounting plate 160.

Once the lower, rotatable barrel component 162 has been secured to the rotatable mounting plate 160, a manufacturer/assembler can rotate or pivot the rotatable mounting plate 160 (and the standoff barrel 122a, standoff extender 124, and mounting cap 126 secured thereto) about the lower, rotatable barrel component 162 (and thus the connector bar 112 and support surface to which it is attached). In particular, as shown in FIG. 4, a manufacturer/assembler can rotate, swivel, or pivot the rotatable mounting plate 160 through a range up to 360° in the direction 151. In additional implementations, the range of motion of the rotatable mounting plate 160 can be limited to less than 360°. For example, in some implementations, range through which a manufacturer/assembler can rotate the rotatable mounting plate 160 about lower rotatable barrel component 162 can be one-hundred and eighty degrees (180°).

Additionally, the variable length standoff 120a can further comprise a mounting plate locking mechanism for securing or locking the rotatable mounting plate 160 relative to the lower rotatable barrel component 162. In particular, the mounting plate locking mechanism can be configured similarly to the extender locking mechanism and the connector bar locking mechanism described herein above in relation to variable length standoff 120. Thus, the mounting plate locking mechanism can lock the rotatable mounting plate 160 and the components secured thereto (i.e., standoff barrel 122a, standoff extender 124, and mounting cap 126) in a fixed position or orientation relative to the lower, rotatable barrel component 162 in the plane including the direction 151.

In addition to the capability to rotate about the connector bar in a first plane, the variable length standoff 120a can be configured to rotate about the connector bar 112 in a second plane, transverse to the first plane. For example, FIG. 4 illustrates that the lower, rotatable barrel component 162 and the components attached thereto (i.e., rotatable mounting plate 160, standoff barrel 122a, standoff extender 124, and mounting cap 126) can be configured to rotate or swivel about the connector bar 112 in the direction 150. Thus, a manufacturer/assembler can rotate or pivot the lower, rotatable barrel component 162 about the connector bar 112 through a range of up to 360°, in a fashion similar to which the standoff barrel 122 described above in relation to FIGS. 2-3 is configured to rotate about the connector bar 112.

In particular, as shown in FIGS. 4 and 5, a manufacturer/assembler can secure the connector bar 112 within a lower hollow portion 182 extending through the lower, rotatable barrel component 162. The lower hollow portion 182 can comprise a hole formed in the lower or proximate portion of lower, rotatable barrel component 162. As with hollow portion 152. The geometry of the lower hollow portion 182 can be configured in size and shape to correspond with the geometry of the connector bar 112.

Additionally, the variable length standoff 120a can further comprise a connector-bar locking mechanism for holding and adjusting the lower, rotatable barrel component 162 at various positions or angles relative to the connector bar 112. Thus, a manufacturer/assembler can use the connector-bar locking mechanism to lock the variable length standoff 120a in a fixed position relative to the connector bar 112. According to one implementation of the present invention, the connector-bar locking mechanism can comprise a lower, transverse set screw. For example, the lower, rotatable barrel component 162 can comprise a lower, transverse receptacle (e.g., like 132, 154, 180, etc.) configured to receive a set screw (not shown). A manufacturer/assembler can tighten the set screw within the lower, transverse receptacle until it engages and secures the lower, rotatable barrel component 162 in place relative to the connector bar 112. According to additional implementations of the present invention, the connector-bar locking mechanism can comprise a clamp or other fastener.

Additionally, as mentioned previously, the manufacturer/assembler can mount the connector bar 112 to a support surface. For example, as shown in FIGS. 4 and 5, the manufacturer/assembler can secure a frame 190 to the support surface. Thereafter, the manufacturer/assembler can affix the connector bar 112 to the frame via a coupler component 192. Then the manufacturer/assembler can secure one or more variable length standoffs 120, 120a to the connector bar 112 as described herein above.

Implementations of the present invention can also include angle tools for aid in aligning the various components of the variable length standoffs 120, 120a. In one implementation, a manufacturer/assembler can use the angle tools for setting the angle between two pieces, such as may be predetermined in shop drawings or a project model. For example, and as described more fully below, the angle tools can allow a manufacturer/assembler to set a prescribed angle between the standoff barrel 122, 122a or lower, rotatable barrel component 162 and the connector rod 112. Similarly, the angle tools can be used to align the rotatable mounting plate 160 relative to the lower, rotatable barrel component 162 or connector bar 112.

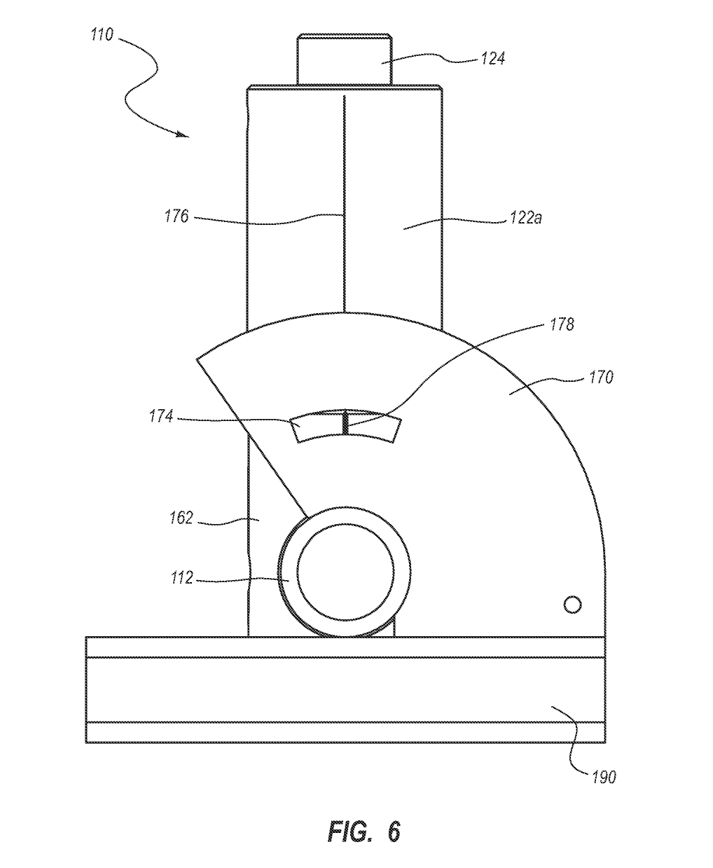

For instance, FIGS. 4-6 illustrate additional implementations for ensuring that the variable angle standoff 120, 120a is appropriately adjusted and aligned in a precise with respect to the connector bar 112 and/or corresponding frame support 190 or support surface. In particular, FIGS. 4-6 show that the variable angle standoff assembly 110 can further include an angle tool including a protractor 170 and a protractor window 174 formed therein. In particular, the manufacturer/assembler can add or mount the protractor 170 during assembly of the connector bar 112, frame 190, and variable length standoff 120, 120a.

The manufacturer/assembler can then use the protractor 170 to align the standoff barrel 122, 122a or lower, rotatable barrel component 162 relative to the connector bar 112 at a desired angle. For example, the manufacturer/assembler can use the protractor 170 and protractor window 174 more particularly to align slots or lines 176, 178 formed in the standoff barrel 122, 122a and lower rotatable barrel component 162 to align the variable length standoff 120, 120a at a desired angle(s). In particular, the manufacturer/assembler can peer through the protractor window 174 to move the standoff barrel/lower, rotatable barrel component slots 176, 178 within the protractor window 174, and to a desired angle indicated by a protractor scale (not shown).

According to additional implementations, the angle tools can comprise an angle scale formed directly on one or more components of the variable length standoff assembly 110. For example, FIG. 2 illustrates that the connector bar 112 can include an angle scale 196. Furthermore, FIG. 2 illustrates that the standoff barrel 122 can include a line or slot 198 configured for use with the angle scale 196. In particular, the manufacturer/assembler can align the slot 198 with the angle scale 196 to align the variable length standoff 120 at a desired angle about the connector bar 112. Similarly, FIG. 5 illustrates that the rotatable mounting plate 160 can include an angle scale 194 formed about the perforation 168 and the pivot rod 158 can include a line or slot 156 configured for use with the angle scale 194. In particular, the manufacturer/assembler can align the slot 156 with the angle scale 194 to align the rotatable mounting plate 160 (and the components secured thereto) at a desired angle relative to the lower, rotatable barrel component 162.

One will appreciate that adding angle tools in this manner can allow the manufacturer/assembler to align the various rotatable components of the variable length standoff 120, 120a with relatively high degrees of granularity and precision, particularly depending on the granularity with which the various scales (protractor scale, and scales 194, 196) are calibrated. Additionally, a manufacturer/assembler can use the angle tools to align one or more components of a first variable length standoff 120, 120a at the same angle(s) as one or more components of one or more additional variable length standoffs 120, 120a. Similarly, the angle tools can enable a manufacturer/assembler to align a first variable length standoff 120a, 120a at a first angle(s), and one or more additional variable length standoffs 120, 120a at different or varying angle(s).

One will appreciate that any or all of the components of the variable length standoffs 120/120a and variable length standoff assembly 110 can be formed from primarily metallic materials. Of course, one will appreciate that any or all of the components illustrated or otherwise described herein can comprise any number of different materials, including any number or type of sufficiently rigid synthetic or naturally occurring metals, rubber or plastic materials, and/or combinations thereof. In particular, virtually any materials of appropriate strength can be used to form or otherwise prepare the variable length standoff assembly components, depending on the functional and/or aesthetic needs of the manufacturer/assembler. For example, in some cases, the materials are chosen not only for strength and rigidity, but also for various aesthetic concerns, including polish, degree of translucence, or ability to match coloration with a given panel, etc.

The present invention also includes methods of assembling and securing one or more panels to a support structure. The following describes at least one implementation of a method of mounting a panel 102 to support, such as shown in FIGS. 1-5. Of course, as a preliminary matter, one of ordinary skill in the art will recognize that the methods explained in detail can be modified to install a wide variety of panels in a wide variety of orientations to a wide variety of support structures according to one or more implementations of the present invention.

For example, at least one method of the present invention comprises an act of securing at least one connector bar of a variable length standoff assembly, including at least one adjustable, variable length standoff, to a support structure. For example, a manufacturer/assembler affixes a connector bar 112 of a variable length standoff assembly 110 to a support structure 104. The act of securing at least one connector bar to a support structure can further include securing a frame to the support structure and then securing the connector bar to the frame. For example, the manufacturer/assembler mounts a frame 190 to the support structure 104 (e.g., wall, ceiling, or both, etc.) and then secures the connector bar 112 top to the frame via the coupling component 192.

The method can also include an act of rotating the at least one variable length standoff of the standoff assembly about the at least one connector bar in one or both of a first and a second plane. For example, a manufacturer/assembler rotates at a standoff barrel 122 or a lower rotatable barrel component 162 about a connector bar 112. Additionally or alternatively, the manufacturer/assembler rotates a rotatable mounting plate 160 about a lower rotatable barrel component 162.

The act of rotating at least one variable length standoff of the standoff assembly about the at least one connector bar can further include using an angle tool to orient the at least on variable length standoff relative to the connector bar. For example, the manufacturer/assembler aligns a slot 176, 178 formed in a component of the variable length standoff 120, 120a within a window 174 of a protractor 170 to position the variable length standoff 120, 120a in a desired orientation relative to the connector bar 112. Alternatively or additionally, the manufacturer/assembler aligns a slot or line 156, 198 formed in a component 122, 122a, 162, 158 of the variable length standoff 120, 122a with an angle scale 194, 196 formed on another component 112, 160 of the variable length standoff assembly 110.

The act of rotating at least one variable length standoff of the standoff assembly about the at least one connector bar can further include locking the at least one variable length standoff in a fixed position relative to the at least one connector bar. For example, the manufacturer/assembler can use a locking mechanism to fix the variable length standoff 120, 122a at one or more desired angles. For instance, the manufacturer/assembler inserts a set screw within a receptacle 154 etc., to lock a rotatable component 122, 162 relative to the connector bar 112.

In addition, the method can include an act of adjusting a length of at least one variable length standoff assembly relative to the connector bar. For example, the manufacturer/assembler slides a standoff extender 124 within one or more cavities 130, or along a groove, of a standoff barrel 122, 122a. Alternatively or additionally, the manufacturer/assembler adds segments to the standoff extender 124. Additionally, the act of adjusting a length of at least one variable length standoff assembly relative to the connector bar can further include locking a standoff extender in a fixed position relative to the connector bar. For example, a manufacturer/assembler locks a standoff extender 124 in a fixed position relative to a standoff barrel 122, 122a by securing a set screw within a transverse extender receptacle 132, 180.

Furthermore, the method can include an act of mounting at least one panel to the at least one variable length standoff. For example, the manufacturer/assembler mounts a panel 102 to a standoff extender 124 of a variable length standoff 120, 120a. Furthermore, the manufacturer/assembler can orient one or more perforations of a given panel 102 with the corresponding standoff extender 124 and vice versa, so that the perforations register with a threaded receptacle 144 of each standoff extender 124. Thereafter, the manufacturer/assembler inserts the threaded stem 128 of a mounting cap 126 through each registered panel perforation and into the threaded receptacle 144 on the other side of the panel 102. The manufacturer/assembler then fastens a cap 129 onto the threaded stem 128 so that the mounting cap 126 securely holds the panel 102 to the standoff extender 124. The act of mounting at least one panel to the at least one variable length standoff can further include mounting a curved resin-based panel to at least one variable length standoff that has been adjusted in at least one of length and orientation to accommodate for the curvature of the resin-based panel.

Accordingly, implementations of the present invention provide a number of different advantages in terms of mounting a wide range of different panel designs, including those of different shapes, conformations, or having specific mounting angles. In particular, the ability to change a mounting interface to any one of 360 different degrees with respect to a connector bar in at least two planes provides a great deal of flexibility for mounting panels to a support structure. Furthermore, the ability to adjust the length of any given standoff in the standoff assembly provides a number of different advantages for mounting such panels, and ensures that almost any mounting angle can be accommodated in a secure fashion.

One will appreciate that implementations of the present invention can also be applied broadly with several different types of alterations within the scope of the present invention for yet additional advantages. For example, a variable length standoff of the present invention can include the ability to be adjusted in length but not angle. For example, the standoff barrel 122, 122a and standoff extender 124 of a variable length standoff can be secured directly to a support surface and not to a rotatable mounting plate 160 or connector bar 112. Similarly, a variable length standoff of the present invention can include the ability to be adjusted in angle in or more planes, but not have the ability to vary in length. For example, the variable length standoff 120, 120a can include a conventional, non-lengthenable standoff barrel in place of the standoff barrel 122, 122a and standoff extender 124.

The present invention may thus be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. In an architectural environment in which a manufacturer mounts one or more decorative architectural panels to a support structure, a variable length standoff assembly for mounting one or more panels to the support structure with variable distance or angling therebetween, comprising:
a standoff barrel configured to be secured to a support structure on one end; and
a standoff extender configured to secure at least a portion of a panel to the standoff barrel with variable distance;
wherein the standoff extender is coupled to the standoff barrel in a telescoping manner such that the standoff extender can secure a panel to the support structure in a plurality of different contracted or extended positions relative to the standoff barrel.

2. The variable length standoff assembly as recited in claim 1, further comprising:
a connector bar rotatably secured to a variable length standoff;
wherein:
the variable length standoff comprises the standoff barrel and standoff extender; and
the variable length standoff is rotatable about the connector bar in at least one plane.

3. The variable length standoff assembly as recited in claim 2, wherein the variable length standoff is configured to rotate through a range of up to 360 degrees with respect to the connector bar.

4. The variable length standoff assembly as recited in claim 2, wherein the variable length standoff is rotatable about the connector bar in at least two planes.

5. The variable length standoff assembly as recited in claim 2, further comprising an angle tool configured to indicate the orientation of the variable length standoff relative to the connector bar.

6. The variable length standoff assembly as recited in claim 5, wherein:
the angle tool comprises a protractor including a window; and
the standoff barrel comprises a slot configured to be viewed though the window to indicate the position of the standoff barrel relative to the connector bar.

7. The variable length standoff assembly as recited in claim 2, further comprising:
a lower, rotatable barrel component secured at a first, proximate end to the connector bar; and
a rotatable mounting plate rotatably secured at an end to a distal end of the lower, rotatable barrel component and secured to a proximate end of the standoff barrel;
wherein the rotatable mounting plate is configured to swivel the standoff barrel relative to the lower, rotatable barrel component.

8. The variable length standoff assembly as recited in claim 7, wherein the variable length standoff is configured to swivel through a range of up to 360 degrees with respect to the lower, rotatable barrel component.

9. The variable length standoff assembly as recited in claim 2, further comprising a barrel locking mechanism configured to lock the variable length standoff in a fixed position relative to the connector bar.

10. The variable length standoff assembly as recited in claim 1, further comprising an extender locking mechanism configured to lock the standoff extender in a fixed position relative to the standoff barrel.

11. The variable length standoff assembly as recited in claim 1, wherein the standoff extender is configured to be at least partially received and slide within a cavity of the standoff barrel.

12. The variable length standoff assembly as recited in claim 1, wherein the standoff extender comprises a plurality of segments configured to be secured to one another to add or remove length from the standoff extender.

13. In an architectural environment in which a manufacturer mounts one or more decorative architectural having a plurality of differently angled, shaped, or oriented panel portions to a support structure using the same standoff assembly, a variable length standoff assembly comprising:
at least one connector bar secured to a support surface; and
a plurality of variable length standoffs secured to the at least one connector bar including at least one standoff adjusted to secure a panel portion to the support surface at an angle, and at least another standoff adjusted to secure another panel portion to the support surface at another angle;
wherein the orientation of each variable length standoff of the plurality of variable length standoffs is configured to be individually adjusted in distance or angle relative to the at least one connector bar in at least one plane.

14. The variable length standoff assembly as recited in claim 13, wherein each variable length standoff is individually adjusted relative to the connector bar in two planes.

15. The variable length standoff assembly as recited in claim 13, wherein:
the support surface comprises a non-standard mounting surface; and
each variable length standoff is individually adjusted to compensate for surface irregularities of the support surface.

16. The variable length standoff assembly as recited in claim 13, wherein the at least one standoff is oriented at the angle in a first plane and a second angle in a second transverse plane.

17. The variable length standoff assembly as recited in claim 16, wherein the at least another standoff is orientated at another angle in the first plane and a third angle in the second plane.

18. In an architectural design space, a method of securely assembling a panel to a support structure using a variable length standoff assembly, comprising:
securing at least one connector bar of a variable length standoff assembly to a support structure, wherein the variable length standoff assembly comprises at least one adjustable, variable length standoff;
rotating at least one variable length standoff of the standoff assembly about the at least one connector bar in one or both of a first and a second plane;
adjusting a length of the at least one variable length standoff assembly relative to the connector bar; and
mounting at least one panel to the at least one variable length standoff.

19. The method as recited in claim 18, wherein rotating at least one variable length standoff about the connector bar comprises rotating a standoff barrel about a connector bar.

20. The method as recited in claim 18, wherein rotating at least one variable length standoff about the connector bar comprises swiveling a rotatable mounting plate about a base member secured to the connector bar.

21. The method as recited in claim 18, further comprising using an angle tool to orient the at least on variable length standoff relative to the connector bar.

22. The method as recited in claim 21, wherein using an angle tool further comprises aligning a slot formed in the at least one variable length standoff within a window of a protractor.

23. The method as recited in claim 18, further comprising:
securing a connector bar to a non-standard mounting surface; and
adjusting the at least one variable length standoff in at least one of length and orientation to accommodate for any surface inconstancies of the non-standard mounting surface.

24. The method as recited in claim 18, further comprising adjusting a length of the at least one variable length standoff assembly relative to the connector bar by adding or removing segments to a standoff extender.
